(19) United States
(12) Patent Application Publication
(10) Pub. No.: US 2006/0048236 A1
(43) Pub. Date: Mar. 2, 2006

(54) Licensing the use of software to a particular user

(75) Inventors: Boyd Cannon Multerer, Seattle, WA (US); Ling Tony Chen, Bellevue, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation, Redmond, WA (US)

(21) Appl. No.: 10/931,838

(22) Filed: Sep. 1, 2004

(51) Int. Cl. H04L 9/32; H04L 9/00; G06F 17/30; H04K 1/00; G06F 7/04; G06K 9/00; H03M 1/68; H04N 7/16

(52) U.S. Cl. 726/28; 713/182

(57) ABSTRACT

The use of software is licensed to a particular user, regardless of the computing device on which the software has been launched. A computing device is logged onto a central service. The central service either directly approves the launching of the software or it provides a code to the computing device, which in turn, unlocks the appropriate software (or features of software) residing on, or being used in conjunction with, the computing device. The approval or unlocking code may be provided after payment or another condition is satisfied. The software is usable on any computing device that is logged onto a central server, via a user's valid account. The central service may unlock the software for the entire time a user is logged in to the central service, or there may be a time limit that the user is able to access the software. Authorization to use the software on any computing device may be granted while the user has a valid account or subscription to the service, or may be limited to a predetermined time period (e.g., a rental period of 30 days).

### FIELD OF THE INVENTION

The present invention is directed to controlling the distribution of software, and more particularly, to licensing the use of software.

### BACKGROUND OF THE INVENTION

Protecting rights of digital content, such as software, has become increasingly difficult in this digital age. Unauthorized copying and sharing of software is rampant.

One popular approach for protecting rights of digital content is the use of a Digital Rights Management (DRM) system. Conventional DRM systems typically include at least two parties: a content provider and a rights entity. In operation, the user registers with the rights entity and obtains a decryption means. When the user requests digital content from the content provider, the digital content is sent to the user as an encrypted file. The digital content in the file can be accessed after the file has been decrypted using the decryption means.

Conventional DRM systems work well for protecting digital content that is strictly data in nature. Digital data such as music files and video files can be protected using a variety of encryption schemes. However, encryption does not work well for protecting computer software. Unlike data, computer programs are designed to perform operations and often require installation. It is not efficient to use encryption to protect a computer program due to architectural complexity and extraneous operation overhead associated with the required decryption mechanisms.

Currently, with respect to software that is stored on physical media, such as a disk, the license to use the software is implied to travel with the media itself. Because of this, many users who are not rightfully licensed to use the software may use the software, while being either unaware of the need for a license or willfully ignoring the need for a license. For example, in some high piracy regions, a user is able to purchase unauthorized disks containing copies of computer software. Because the user has purchased a disk containing the software, there is an implication, at least to the user, that the software is properly licensed, regardless of whether or not a proper license has actually been procured. This pirated software may be run on any appropriate computer without the user procuring a license to use that software. It would be desirable to prevent the use of software without a proper license and to separate the delivery of the license to use software from the delivery of the media containing the software.

Some conventional methods prevent unauthorized distribution of a computer-executable program by encrypting the entire file containing the program. The encrypted file is then transmitted to an intended user who has been given the proper decryption means. After the file has been transmitted, the user has to decrypt the file before installing and using the program. However, once the program has been decrypted, the program is no longer protected from unauthorized use.

An effective and efficient system and method for controlling illegal distribution and licensing of computer software eludes those skilled in the art.

### SUMMARY OF THE INVENTION

The present invention is directed to licensing the use of software to a particular user, regardless of the computing device on which he is using the software. A computing device is logged onto a central service. The central service either directly approves the launching of the software or it provides a code to the computing device, which in turn, unlocks the appropriate software (or features of software) residing on, or being used in conjunction with, the computing device. For example, the software may be resident on a computer-readable medium, such as a disk, that has been provided to the computing device.

The approval or unlocking code may be provided after payment or another condition is satisfied. The software is usable on any computing device that is logged onto a central server, via a user's valid account.

The central service may unlock the software for the entire time a user is logged in to the central service, or there may be a time limit that the user is able to access the software. Authorization to use the software on any computing device may be granted while the user has a valid account or subscription to the service, or may be limited to a predetermined time period (e.g., a rental period of 30 days).

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing a multimedia console in which aspects of the present invention may be implemented;

FIG. 2A is a schematic diagram of an exemplary software activation control system in accordance with the present invention;

FIG. 2B is a schematic diagram of another exemplary software activation control system in accordance with the present invention;

FIG. 3A is a flow diagram of an exemplary method of providing access to software in accordance with the present invention;

FIG. 3B is a flow diagram of another exemplary method of providing access to software in accordance with the present invention; and

FIG. 4 is a flow diagram of another exemplary method of providing access to software in accordance with the present invention.

### DETAILED DESCRIPTION OF ILLUSTRATIVE EMBODIMENTS

Overview

Software may be licensed for use by a particular user on any computing device, or more particularly, any CPU on a computing device, such as a gaming console or a multimedia console. A computing device is connected to a central service, and a user who has subscribed to the service, or is a potential subscriber, may log on via the computing device. Approval of the launching of the software or a code is provided from a distribution service to the computing device, which unlocks the appropriate software or portion of software for use with the associated computing device. The software may reside on a computer-readable medium, such as a CD-ROM or DVD, that is being used in conjunction with the computing device. The approval or unlocking code may be provided pursuant to a condition, such as appropriate payment, being satisfied. The software is usable on any computing device that is logged onto a central server, via a user's valid account.

Exemplary Computing Environment

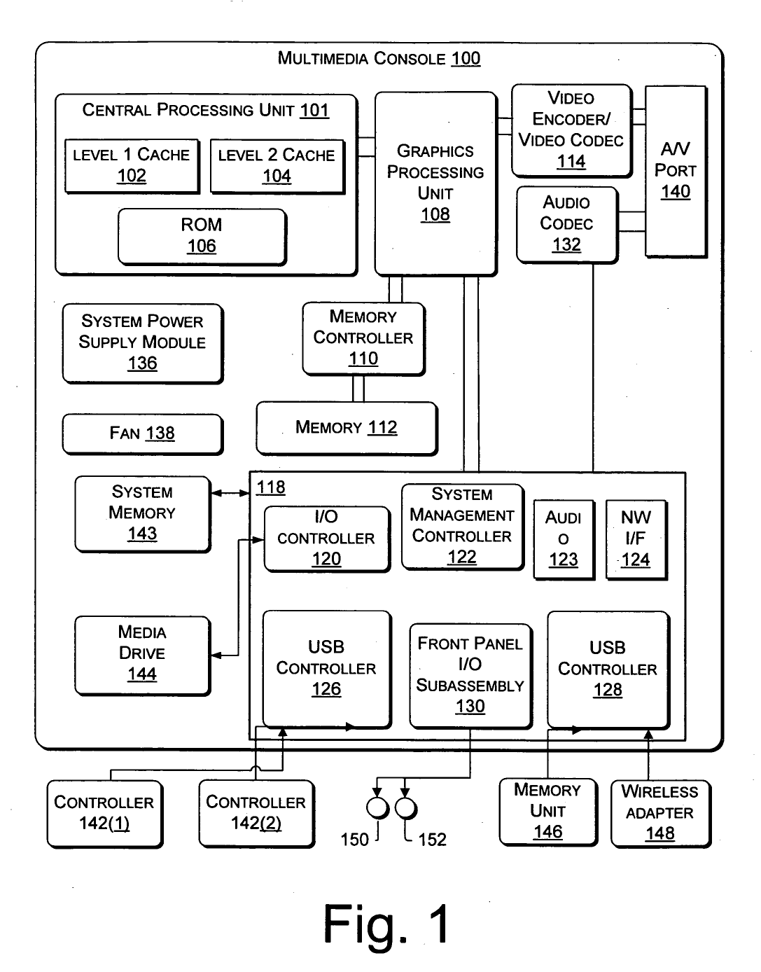

FIG. 1 illustrates the functional components of a multimedia console 100 in which certain aspects of the present invention may be implemented. The multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128, and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless interface components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications, and drivers. The CPU reservation is preferably maintained at a constant level.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of game resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus multimedia application threads. The system applications are preferably scheduled to run on the CPU 101 at predetermined times and intervals in order to provide a consistent system resource view to the application. The scheduling is to minimize cache disruption for the multimedia application running on the console.

When a concurrent system application requires audio, audio processing is scheduled asynchronously to the multimedia application due to time sensitivity. A multimedia console application manager controls the multimedia application audio level (e.g., mute, attenuate) when system applications are active.

Input devices (e.g., controllers 142(1) and 142(2)) are shared by multimedia applications and system applications. The input devices are not reserved resources, but are to be switched between system applications and the multimedia application such that each will have a focus of the device. The application manager preferably controls the switching of the input stream, without the multimedia application's knowledge, and a driver maintains state information regarding focus switches.

### Exemplary Embodiments

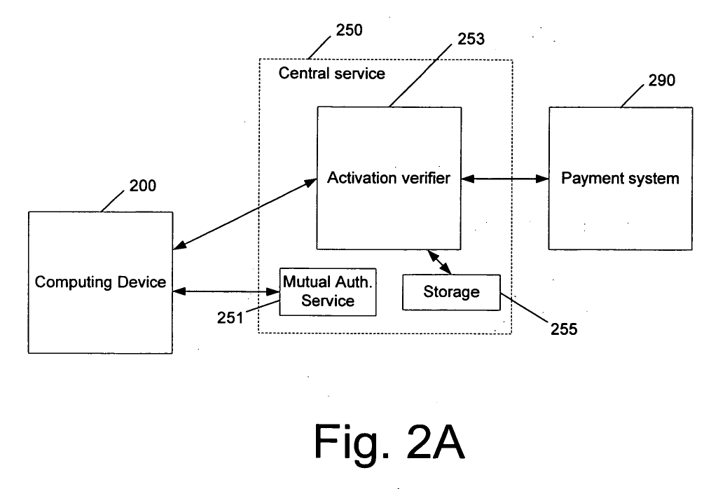

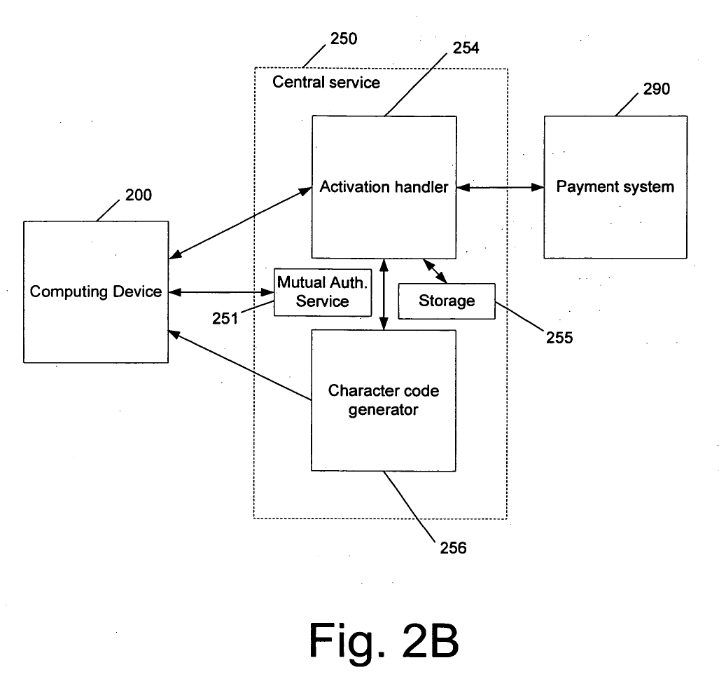

FIG. 2A is a schematic diagram of an exemplary software activation control system in accordance with the present invention. A computing device 200 is connected to a central location 250, such as a server residing on a network or a website on the Internet, for example. A user has an account or subscription associated with the central location. The account or subscription allows a user to access software (e.g., games, applications, etc.) residing on any computing device. In other words, the account or subscription provides the user with approval or authorization to use the software on whatever computing device he desires, as long as that computing device is connected to the central location and the user has appropriately been logged in to the central location and identified. Thus, the user is not restricted to using the software on a particular computing device. The software is licensed to a particular user, not a particular computing device.

For illustrative purposes, the central service 250 is shown to include a mutual authentication service 251 and activation verifier 253. A storage device 255 may be used to store data associated with subscribers, such as which applications a subscriber is authorized to use (e.g., has paid for), and for how long (e.g., lifetime, 30 days, etc.). A payment system 290 may also be used to receive payment from a user for a software program that is to be activated by the activation control system. The payment system 290 may be part of the central service 250 or a separate entity, for example.

A mutual authentication service 251 is used for mutually authenticating the computing device 200 to the central service 250. A user may log into the central service 250 and is identified and authenticated via the mutual authentication service 251 using well known techniques.

Activation verifier 253 is a computer-executable component that handles the verification of software for computing devices, such as computing device 200. After the client computing device 200 is mutually authenticated to the central service 250, the activation verifier receives and processes a request from the computing device for authorization to run a software application on the computing device 200. The activation verifier 253 checks storage (e.g., storage 255) and responds to the request accordingly with an approval or activation indicator, e.g., with a “yes” or “no” to allowing the software application to run on the computing device 200. For example, if storage contains information that says the logged in user is a subscriber to that particular software application, the activation verifier 253 sends a “yes” to the computing device 200, which in turn, allows the software application to be run. Otherwise, the activation verifier 253 sends a “no” to the computing device 200, which prohibits the software application from being run. Thus, for each request for authorization to use a software application on the computing device 200, activation verifier 253 facilitates the activation of the software that is keyed to a particular user with a user identification that is unique to the user.

The use of mutual authentication between the computing device 200 and the central service 250 prevents a user from creating a “fake” server that tricks the computing device with a fake approval or activation indicator.

When a request for software is received, activation verifier 253 is configured to receive a user identification associated with the user who is using the computing device 200 on which the software will be run. Desirably, the computing device 200 is connected to the activation verifier 253 (e.g., via the mutual authentication service 251 or elsewhere on the central service 250) to receive a user's login information. Any type of wired or wireless network connection that enables activation verifier 253 to obtain data from the computing device may be used to establish the communication link. For example, activation verifier 253 may interact with the computing device through the Internet, a LAN, a wireless communication network, and the like.

Desirably, the central service is contacted each time the program is launched on any computing device. Thereafter, after identifying and validating the user, the authorization for use is provided on the computing device that the validated user is presently logged onto. The program will properly operate only if an approval or activation indicator that the software program has been properly licensed to the user, is provided. It is noted that the software program may be any application or portion of an application, such as a game, a level of a game, a feature of a game, etc.

FIG. 2B is a schematic diagram of another exemplary software activation control system in accordance with the present invention. FIG. 2B contains elements similar to those described above with respect to FIG. 2A. These elements are labeled identically and their description may be omitted for brevity.

For illustrative purposes, the central service 250 is shown to include an activation handler 254 and a character code (also referred to as an unlocking code or activation code) generator 256. However, in practice, the activation handler 254 and the character code generator 256 may be combined into a single component. A storage device 255 and payment system 290, as set forth above, are also provided. A mutual authentication service 251 is also provided to mutually authenticate the computing device 200 to the central service 250.

Activation handler 254 is a computer-executable component that handles the activation of software for computing devices, such as computing device 200. Activation handler 254 is configured to process requests for software licenses and unlock authorization for use on computing devices. For each request for a software license or other authorization to use, activation handler 254 facilitates the activation of the software that is keyed to a particular user with a user identification that is unique to the user.

When a request for software is received, activation handler 254 is configured to receive a user identification associated with the user who is using the computing device 200 on which the software will be run. Desirably, the computing device 200 is connected to the activation handler 254 (e.g., via the mutual authentication service 251 or elsewhere on the central service 250) to receive a user's login information. Any type of wired or wireless network connection that enables activation handler 254 to obtain data from the computing device may be used to establish the communication link. For example, activation handler 254 may interact with the computing device through the Internet, a LAN, a wireless communication network, and the like.

Character code generator 256 is a computer-executable component that creates an unlocking code for use on the computing device 200 that allows the particular software program to be used on the computing device 200 that the verified user is currently using. Any type of unlocking code may be generated and used, and examples are described below. The unlocking code is then provided to the computing device 200, e.g., via the activation handler 254.

Desirably, the central service is contacted each time the program is launched on any computing device. Thereafter, after identifying and validating the user, the unlocking code is desirably generated (exemplary techniques are described below) for use on the computing device that the validated user is presently logged onto. The program will properly operate only if the unlocking code, or other indicator that the software program has been properly licensed to the user, is provided. As noted above, the software program may be any application or portion of an application, such as a game, a level of a game, a feature of a game, etc.

Thus, the software application is activated when connected to a central location or service. The user pays for per software application activation and can use the application on any computing device or multimedia console, for example, as long as he maintains a subscription to the central service and logs on to the central service during the time he is using the application. A short term rental period is contemplated. Moreover, it is contemplated that a user may be provided access to multiple applications if he has a premium subscription.

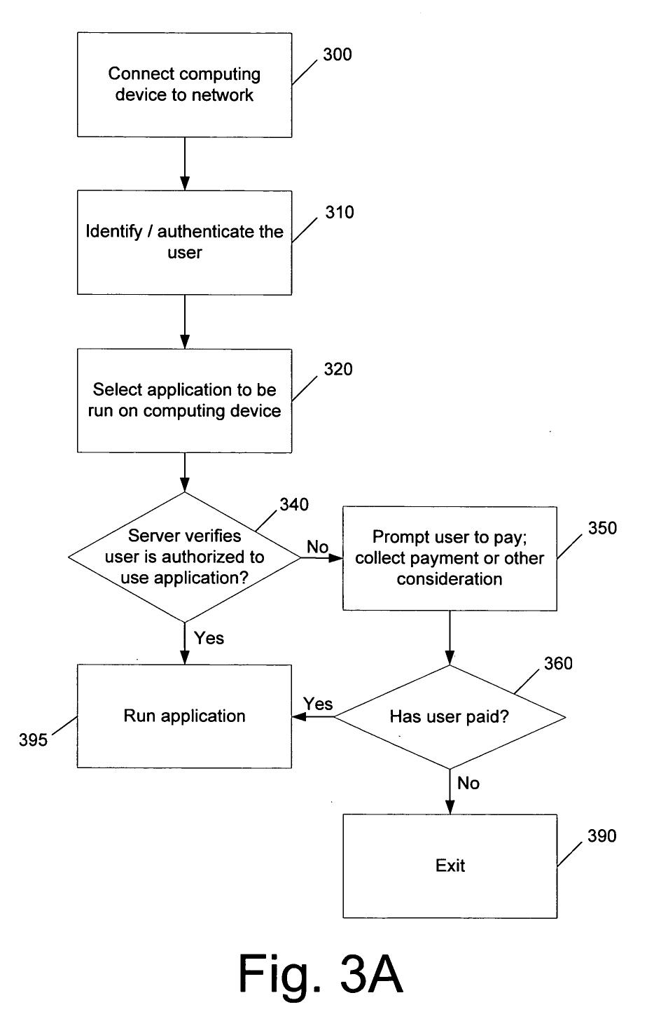

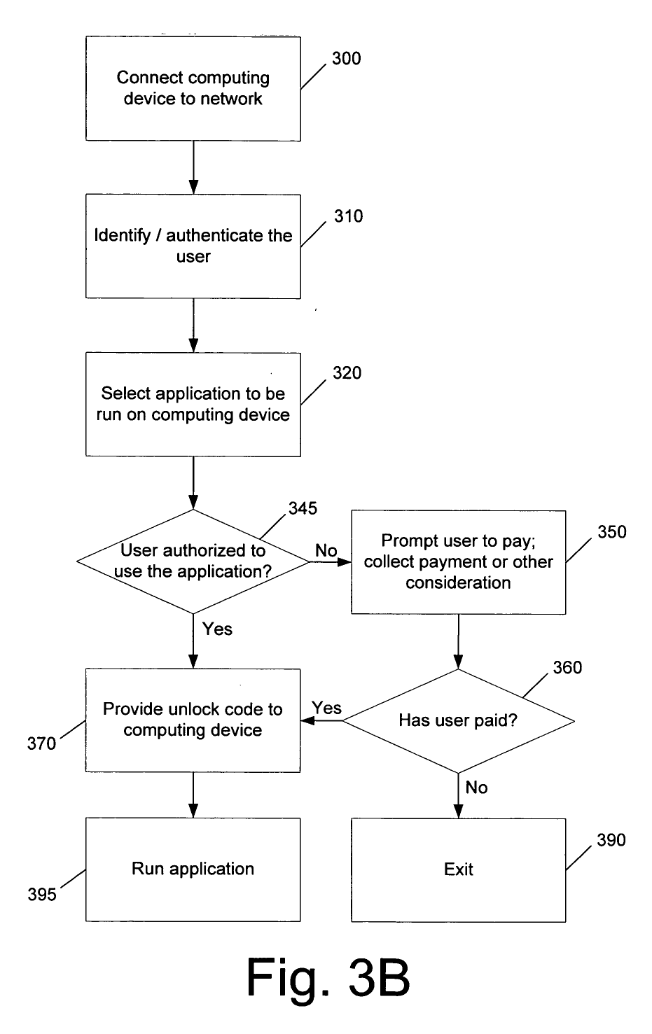

FIG. 3A is a flow diagram of an exemplary method of providing access to a software application in accordance with the present invention. In this exemplary embodiment, the computing device on which the software application is to be run is desirably connected to a central service, which may be affiliated with a website on a network, such as the Internet, for example. A software activation check is desirably performed before the application will be permitted to run on the computing device. Thus, the user is not seeking to unlock applications residing on a server, but instead is seeking to unlock applications residing on a client computing device.

At step 300, a computing device is connected to a central location or service that oversees user accounts and subscriptions. The user logs in to the central service and is identified and authenticated using well known techniques, at step 310. Every time a user wants to use the software application, the computing device desirably accesses the central service to determine whether the approval or authorization is to be granted. A license for use is tied to the online account that a user has established. Thus, software is unlocked on a per subscriber basis.

After the user has been identified and authenticated (e.g., using a mutual authentication service), an application to be run on the computing device is selected, at step 320, and this selection (e.g., the title of the software application) is provided to the central service. The application checks with the central service for subscription status. At step 340, the central service verifies that the user is authorized to use the application. Authorization may be based on whether the user has paid for access to the application. A data storage device (e.g., storage device 255) may comprise a table or database, for example, that lists each subscriber and the applications he is authorized to use along with any restrictions (e.g., time restrictions, such as usage is permitted until a certain calendar date).

If the central service determines that the user is authorized to use the application, the central service provides an approval code or other type of activation, approval, or authorization indicator to the computing device, and the application may then be run on the computing device, at step 395, pursuant to the approval code. The approval code or indicator may unlock certain features of the application, rather than the entire application itself. Additional payment or other consideration may be used to access additional features.

If the central service determines that the user is not approved or authorized to use the application, the user may be prompted to pay or otherwise register to use to the selected application, at step 350. A user interface, for example, may be provided to the user with instructions on how to buy, or otherwise procure, a license to use the software product residing on the computing device. Moreover, the application may allow a user to view subscription choices and sign up for subscription levels. Subscriptions can provide access to games or applications by a single publisher, games or applications in a given genre, games or applications that have been released more than a certain number of months ago, etc. Limited life (rental) licenses could also be granted that unlock the games or applications for a specific length of time and then expire. Alternately, additional instructions on how to proceed may be provided to the user.

At step 360, it is determined if the user has paid for a license and is thus now approved or authorized to use the application. If so, then an approval code or indicator is provided to the computing device, and the application is run, at step 395. If the user still has not been authorized to use the application, then the activation processing exits or otherwise aborts at step 390, without the user being permitted to use the application on the computing device. Optionally, an error message or other indicator may be displayed or otherwise provided to the user. Moreover, the software program may be disabled or aborted. The computing device may also be disabled, if desired.

FIG. 3B is a flow diagram of another exemplary method of providing access to a software application in accordance with the present invention. FIG. 3B contains steps similar to those described above with respect to FIG. 3A. These steps are labeled identically and their description may be omitted for brevity. Similar to FIG. 3A, a software activation check is desirably performed before the application will be permitted to run on the computing device. Thus, the user is not seeking to unlock applications residing on a server, but instead is seeking to unlock applications residing on a client computing device.

Steps 300 to 320 proceed as in FIG. 3A. At step 345, the central service determines if the user is authorized to use the application. Authorization may be based on whether the user has paid for access to the application, similar to that described with respect to FIG. 3A.

An example is provided in Table 1, which maintains a list of user identifications, product title, and time restrictions. Here, user ID John 1@1 is enabled to play Halo 3 forever (as long as he maintains a valid account with the central service) on any computing device. Alien9!, on the other hand, has authorization to access Halo 3 on any computing device, but only until a certain date (Jun. 30, 2005). Beyond this date, Alien9! will not be able to access Halo 3, unless he purchases an additional license.

In Table 1, 33Tetris has a subscription that enables him to use all Microsoft products on his (or anyone's) computing device, as long as that computing device is properly connected to the central service. User ID RedDog5$ has a subscription to use all Tony Hawk brand games on a computing device for 182 hours. Desirably, this time decreases as RedDog5$ uses a Tony Hawk brand game on any computing device. For example, if the next time RedDog5$ logs into the central service and plays a Tony Hawk game for 4 hours, the time remaining in his license will be reduced to 178 hours. A user may purchase additional time, if desired.

TABLE 1

| User ID | Product | Time |
|---|---|---|
| John1@1 | Halo 3 | Unlimited |
| Alien9! | Halo 3 | Until Jun. 30, 2005 |
| 33Tetris | All Microsoft Products | Unlimited |
| RedDog5$ | All Tony Hawk Games | 182 hours |

If the central service determines that the user is authorized to use the application, the central service generates an unlocking code (as described further herein) and provides the unlocking code to the computing device at step 370. The application may then be run on the computing device, at step 395, in accordance with the unlocking code. For example, the unlocking code may grant unlimited use and access to the application, or may provide a length of time that the application may be used (e.g., 4 hours, 30 days, etc.). Thus, other information may also be provided, such as “seconds until the program expires” which limits the amount of time a user can use the software program. Desirably, the computing device verifies the unlocking code, and enables the application to be run. Moreover, the unlocking code may unlock certain features of the application, rather than the entire application itself. Additional payment or other consideration may be used to access additional features.

Steps 350, 360, and 390 are similar to those described above with respect to FIG. 3A. At step 360, it is determined if the user has paid for a license and is thus now authorized to use the application. If so, then processing continues at step 370. If the user still has not been authorized to use the application, then the activation processing exits or otherwise aborts at step 390, without the user being permitted to use the application on the computing device.

Because the computing device desirably is connected to the central service when seeking approval or authorization to use the desired software application, it is also desirable that a computing device can faithfully check the unlock code. In other words, a user should be prevented from bypassing the approval and/or authorization steps and running the desired software application directly without receiving proper approval or authorization from the central server.

It is contemplated that a user may “rent” a software application, by purchasing a software license for a particular software program to run on any particular computing device for a particular amount of time (e.g., one week, one month, etc.). For example, the approval, unlock, or activation code that is generated and provided may have an expiration time or date associated with it. The expiration period may be checked against a value residing on the computing device, or the computing device may have to check in with, or be connected to, a website while the user is using the software application on the computing device. During mutual authentication, the computing device's notion of the current time should be synchronized with the central service. This is desirable for time based rental. If the user can arbitrarily change the time of the computing device to be at a time before the rental expiration, unauthorized use of the software beyond its authorized rental period may occur.

It is contemplated that other users (e.g., non-subscribers) can use the software application on the same computing device as the logged in subscriber. Thus, if a subscriber logs into the central service and is approved or authorized to use a software application, other users present with the subscriber can use the software application as well. For example, if the software application is a multi-player game, a subscriber may go to a friend's computing device, properly log into the central service, and both the subscriber and his friend may use the game while the subscriber is logged on, although the friend is not a subscriber.

Because the application is licensed to a user via user identification and/or account information, as opposed to a particular computing device, it is contemplated that a first user may provide his valid user identification to a second user. In such a case, the second user may use the first user's identification to log in to a central service and seek authorization to use a software application. This is undesirable, because the second user has not properly paid to access the software application. Aspects of the present invention seek to minimize the likelihood of this illicit use occurring.

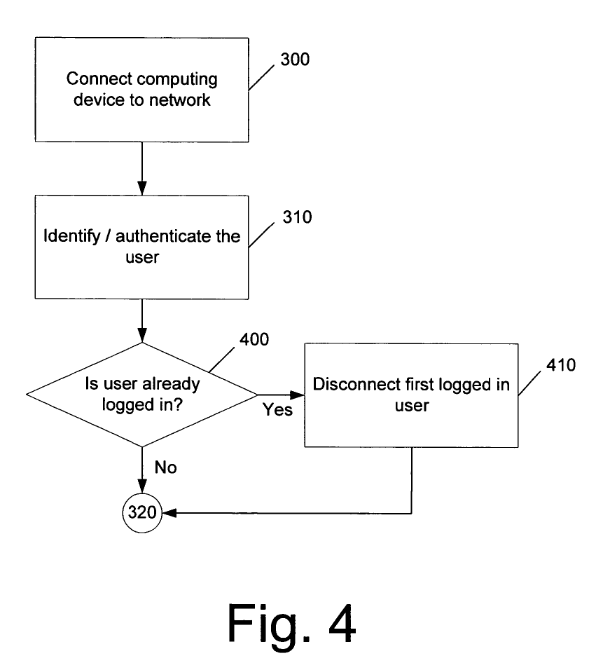

FIG. 4 is a flow diagram of another exemplary method of providing access to software in accordance with the present invention. FIG. 4 is similar to FIGS. 3A and 3B, and description of the similar steps is omitted for brevity. After the user logs into the central service and provides his identification and is authenticated, the central service determines if the user is already logged in, at step 400, with the same account information. After a user logs in, the central service desirably stores the user's identification information and logged in status in storage (e.g., storage device 255) as long as the user is logged in. Then, when a subsequent user logs in, the central service checks its storage to determine if the user (e.g., in particular, the identification information) has already logged in. In such a case, it is determined that two users are attempting to use the same user account or subscriber account, which is undesirable. To prevent multiple concurrent logins using the same user identification information, the central service disconnects the earlier logged in user, at step 410. Disconnecting an earlier logged in user will deter a valid user from sharing his identification information with other, unauthorized parties.

It is contemplated that a user may wish to log into the central service to concurrently use two or more software programs that he is authorized to use. In such a case, instead of the central service determining if the user is already logged in prior to the user selecting the application to be run (as in step 400 in FIG. 4), the central service may wait until after the user has selected the application to determine if the user is already logged in to that particular application. In such a case, step 400 would be performed after step 320 rather than before step 320. In such an embodiment, only if a user was seeking to access the same application as one already being used by that user's account would the central service disconnect the earlier logged in user.

Exemplary techniques of generating an unlocking code are described below. Generation of unlocking codes is not limited to these examples. Any technique for generating an unlocking code may be used with the present invention.

An unlocking code may be generated, for example, by the computing device (or user) providing a unique identifier (e.g., serial number) of the computing device to the activation control system, along with the product identifier (e.g., product code) of the software program or application that is desired to be activated.

Desirably, the identifier of the computing device and the product identifier are signed with a private key (e.g., using RSA signing, DSA signing, or any other private/public key signing technique or system) at the activation control system (e.g., at the character code generator 256). The signed bits may be transformed into an activation code with a predetermined number of alpha-numeric characters (e.g., about 25 to 30 characters).

The signed code or data is then provided to the computing device (e.g., transparently via the network connection). Only the computing device having the computing device's unique identifier will be able to activate the associated software program or application. The computing device uses the corresponding public key to retrieve and verify the unique identifier of the computing device and the product identifier.

It is then determined if the retrieved unique identifier matches the unique identifier of the computing device, and if the retrieved product identifier matches the identifier of the product that the user is trying to run. If either of these comparisons fails, the activation process stops, optionally with an error message or other indicator being displayed or otherwise provided to the user. Moreover, the software program may be disabled or aborted. The computing device may also be disabled, if desired.

If the retrieved unique identifier matches the unique identifier of the computing device, and if the retrieved product identifier matches the identifier of the product that the user is trying to run, then the product is activated and run.

Another method of generating an unlocking code involves the use of a machine key, which differs from the computing device's unique identifier. The machine key is desirably provided (e.g., by the computing device's manufacturer) and stored on the computing device (e.g., in ROM). For example, the key may be a random 128 bit key generated during manufacturing of the computing device. The machine key is not necessarily unique. Preferably, the machine key is stored such that the user cannot easily determine it. For example, the key may be encrypted on the computing device. An activation control system desirably maintains a database, lookup table, or other storage device that associates a computing device's unique identifier with its machine key.

At this point, it is assumed that the user has paid for the product, if payment is desired. A unique identifier (e.g., serial number) of the computing device is provided to the activation control system, along with the product identifier (e.g., product code) of the software program or application that is desired to be activated.

The activation control system looks up the corresponding machine key (symmetric key) from a database (e.g., a database such as a lookup table having two columns, computing device identifier and corresponding machine key), for example, and computes a hash based on the machine key and the product identifier (e.g., a one-way hash such as SHA-1 (machine key|product code)). If the key was encrypted, then it is desirably decrypted prior to the hash determination. An activation code is generated based on the hash. The hash, or some portion of the hash, is converted to user typeable characters. For example, the first 32 bits of the one-way hash can be converted into an 8 character activation code.

The activation code is then provided to the computing device. If the computing device is connected via a network, for example, to the activation control system, the activation control system may provide the activation code to the computing device transparently.

At the computing device, a separate hash is locally computed comprising the machine key and product code. Using the same technique as set forth above, the hash, or some portion of the hash, is converted to user typeable characters.

It is determined if the locally computed activation code matches the activation code determined and provided by the activation control system. If this comparison fails, the activation process stops, optionally with an error message or other indicator being displayed or otherwise provided to the user. If the locally computed activation code matches the activation code determined and provided by the activation control system, then the product is activated and run.

A pit by pit DVD copying technique that may emerge to overcome conventional DVD copy protection will not affect the efficacy of the present invention. Application pricing adjustment is much easier and quicker, without the need for the price change to ripple through retail channels. Game demos can be distributed on a large scale without much extra cost.

A website may be set up to allow a user to purchase the activation and/or upgrade codes for a software program for use on a particular computing device, and can show current unlock prices for the software programs. A website may also display the purchased codes for a particular user.

An exemplary system that provides the unlock and/or upgrade codes can track sales, usage, etc., and thus can log statistics for the unlocked software programs, and provides an authoritative location for current pricing. This also allows the system to do royalty tracking/auditing for third party software publishers.

As mentioned above, while exemplary embodiments of the present invention have been described in connection with various computing devices, the underlying concepts may be applied to any computing device or system.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiments for performing the same functions of the present invention without deviating therefrom. Therefore, the present invention should not be limited to any single embodiment, but rather should be construed in breadth and scope in accordance with the appended claims.

What is claimed:

1. A method for providing access to an application, comprising:
launching an application on a computing device;
receiving an activation code for the application at the computing device from a central service; and
activating the application on the computing device based on the activation code.

2. The method of claim 1, further comprising connecting the computing device to the central service.

3. The method of claim 1, further comprising receiving user identification information at the computing device and authenticating the user prior to receiving the activation code.

4. The method of claim 3, further comprising transmitting the user identification information to the central service, and generating the activation code at the central service based upon the user identification information.

5. The method of claim 4, further comprising determining if a first activation code for the application corresponding to the user identification information has already been generated at the central service, prior to generating the activation code at the central service.

6. The method of claim 5, further comprising disconnecting a first computing device running the application pursuant to the first activation code, and then generating the activation code at the central service for the computing device.

7. The method of claim 1, wherein the activation code comprises a length of time that the application may be run on the computing device.

8. The method of claim 1, further comprising providing payment for the activation code prior to receiving the activation code.

9. The method of claim 1, further comprising determining if the application has already been activated on the computing device prior to receiving the activation code, and only receiving the activation code in the absence of the application having already been activated on the computing device.

10. The method of claim 1, wherein the activation code is based on at least one of a unique identifier of a user, a unique identifier of the computing device, and an application identifier associated with the application.

11. A method for providing access to an application, comprising:
determining an activation code at a central service based on at least one of a unique user identifier, a unique identifier of a computing device on which the application is to be run, and an application identifier associated with the application;
providing the activation code to the computing device; and
activating the application on the computing device responsive to the activation code.

12. The method of claim 11, further comprising determining if the application has already been activated on the computing device prior to determining the activation code, and only determining the activation code in the absence of the application having already been activated on the computing device.

13. The method of claim 11, further comprising collecting payment for the application prior to determining the activation code.

14. The method of claim 11, further comprising launching the application on the computing device prior to determining the activation code.

15. The method of claim 11, further comprising requesting the activation code at the computing device prior to determining the activation code.

16. The method of claim 11, further comprising receiving user identification information at the computing device and transmitting the user identification information to the central service, and generating the activation code at the central service based upon the user identification information.

17. The method of claim 16, further comprising determining if a first activation code for the application corresponding to the user identification information has already been generated at the central service, prior to generating the activation code at the central service.

18. The method of claim 17, further comprising disconnecting a first computing device running the application pursuant to the first activation code, and then generating the activation code at the central service for the computing device.

19. The method of claim 11, wherein the activation code comprises a length of time that the application may be run on the computing device.

20. An activation control system, comprising:
a central service comprising:
an activation handler for receiving a request from a computing device for an activation code for an application to run on the computing device; and
a character code generator for determining the activation code based on at least one of a unique user identifier, a unique identifier of the computing device on which the application is to be run, and an application identifier associated with the application.

21. The system of claim 20, wherein the character code generator provides the activation code to the computing device.

22. The system of claim 20, further comprising a payment system for collecting payment for the application.

23. The system of claim 20, further comprising a storage device for storing subscriber information comprising at least a user identifier and an application associated with the user identifier.

24. The system of claim 23, wherein the subscriber information further comprises a time period for usage associated with the application.

25. The system of claim 20, wherein the activation code comprises a length of time that the application may be run on the computing device.

26. The system of claim 20, wherein the central service is adapted to receive user identification information from the computing device and generate the activation code based upon the user identification information.

27. The system of claim 26, wherein the central service is adapted to determine if a first activation code for the application has already been generated corresponding to the received user identification information, prior to generating the activation code.

28. The system of claim 27, wherein the central service is adapted to disconnect a first computing device running the application pursuant to the first activation code, and then generate the activation code for the computing device.

29. A computing device comprising a central processing unit (CPU) for launching an application on the computing device, requesting and receiving an activation code for the application from a central service, and activating the application on the computing device based on the activation code.

30. The computing device of claim 29, wherein the CPU is adapted to receive payment instructions from an input device, and provide payment to a remote payment system.

31. The computing device of claim 29, wherein the CPU is adapted to determine if the application has already been activated on the computing device prior to requesting the activation code, and only requesting the activation code in the absence of the application having already been activated on the computing device.

32. The computing device of claim 29, wherein the activation code is based on at least one of a unique user identifier, a unique identifier of the computing device, and an application identifier associated with the application.

33. The computing device of claim 29, wherein the activation code comprises a length of time that the application may be run on the computing device.

34. The computing device of claim 29, wherein the CPU is prevented from activating the application if a central service determines that another activation code for the application has already been generated for a received unique user identifier, prior to generating the activation code for the computing device.

35. An activation control system, comprising:
a central service comprising:
an activation verifier for receiving a request from a computing device for an activation code for an application to run on the computing device; and
a mutual authentication service for mutually authenticating the computing device to the central service.

36. The system of claim 35, wherein the activation code comprises a yes/no approval for running the application on the computing device.

37. The system of claim 35, further comprising a payment system for collecting payment for the application.

38. The system of claim 35, further comprising a storage device for storing subscriber information comprising at least a user identifier and an application associated with the user identifier.

39. The system of claim 35, wherein the subscriber information further comprises a time period for usage associated with the application.

40. The system of claim 35, wherein the central service is adapted to receive user identification information from the computing device and generate the activation code based upon the user identification information.
